(19) United States
(12) Patent Application Publication
(10) Pub. No.: US 2007/0009780 A1
(43) Pub. Date: Jan. 11, 2007

(54) Sealing of multi-height surfaces

(75) Inventor: Jeffrey A Smith, Marl (DE)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 10/543,870

(22) PCT Filed: Feb. 2, 2004
(86) PCT No.: PCT/US04/02900

§ 371 Date: Sep. 1, 2006

Related U.S. Application Data
(60) Provisional application No. 60/444,569, filed on Feb. 3, 2003.

(51) Int. Cl. H01M 2/08; H01M 8/02; H01M 4/94

(52) U.S. Cl. 429/35; 429/38; 429/44

(57) ABSTRACT

Fuel cell gaskets are employed to seal around an individual cell of a fuel cell assembly. The individual cell includes a membrane electrode assembly where some of the components do not extend as close to the perimeter of the cell as others, thereby creating a gap. The gaskets, which may be formed of laminated layers, each include a pair of sealing beads extending therefrom. The sealing beads are formed to extend toward and seal against separator plates, and have different heights to account for the gap caused by the discontinuous layers of the membrane electrode assembly.

### BACKGROUND OF INVENTION

This invention relates in general to static seals and more particularly to a gasket employed for sealing between components in a fuel cell.

A fuel cell is an electrochemical energy converter that includes two electrodes placed on opposite surfaces of an electrolyte. In one form, an ion-conducting polymer electrolyte membrane is disposed between two electrode layers (also sometimes called gas diffusion layers), with layers of a catalyst material between the membrane and the electrode layers, to form a membrane electrode assembly (MEA). The MEA is used to promote a desired electrochemical reaction from two reactants. One reactant, oxygen or air, passes over one electrode while hydrogen, the other reactant, passes over the other electrode. The oxygen and hydrogen combine to produce water, and in the process generate electricity and heat.

An individual cell within a fuel cell assembly includes a MEA placed between a pair of separator plates (also sometimes called flow field plates). The separator plates are typically fluid impermeable and electrically conductive. Fluid flow passages or channels are formed adjacent to each plate surface at an electrode layer to facilitate access of the reactants to the electrodes and the removal of the products of the chemical reaction.

In such fuel cells, resilient gaskets or seals are typically provided between the faces of the MEA and the perimeter of each separator plate to prevent leakage of the fluid reactant and product streams. Since the fuel cell operates with oxygen and hydrogen, it is important to provide a seal that not only seals well against hydrogen, oxygen and water, but that will seal well as the temperature changes due to the heat that is given off during fuel cell operation. To assure a good seal, the seals need to be formed accurately as well as have the proper sealing force applied along the seal after being assembled into an individual cell. In particular, the appropriate sealing force can be difficult to attain since different layers within the cell may only extend out a portion of the way to the perimeter of the cell. An adhesive (and in particular, a pressure sensitive adhesive) can be employed to aid in the assembly and sealing of components, but it is not always desirable to use an adhesive in a cell assembly. The assembly cycle time may be more than is desirable because one must wait for the adhesive to cure. Moreover, the gasket may need to be thicker than is otherwise necessary in the area of the pressure sensitive adhesive in order to obtain the proper adhesion of the adhesive during assembly.

Thus, it is desirable to have a gasket of an individual cell of a fuel cell that is relatively easy to align and secure to the other components during an assembly operation, while assuring the proper sealing force in the finished assembly.

### BACKGROUND AND SUMMARY OF INVENTION

In its embodiments, the present invention contemplates a seal for use in an individual cell of a fuel cell comprising: a first gasket including a first surface adapted to be adjacent to a first separator plate, a first sealing bead extending beyond the first surface a first distance, and a second sealing bead extending beyond the first surface a second distance, with the second distance being greater than the first distance.

The present invention further contemplates an apparatus for use in an individual cell of a fuel cell assembly comprising: a membrane electrode assembly having a plurality of layers, with a portion of the plurality of layers being discontinuous relative to the other layers; and a first gasket mounted to a first side of the membrane electrode assembly and including a first surface adapted to be adjacent to a first separator plate, a first sealing bead extending beyond the first surface a first distance, and a second sealing bead extending beyond the first surface a second distance, with the second distance being greater than the first distance.

The present invention also contemplates assembling an individual cell of a fuel cell by: providing a membrane electrode assembly; assembling a first side of a first gasket to a first side of the membrane electrode assembly; assembling a first side of a second gasket to a second side of the membrane electrode assembly; assembling a first separator plate to a second side of the first gasket, wherein the first gasket includes a first sealing bead and a second sealing bead extending outward from the second side toward the first separator plate, with the second sealing bead being closer to a perimeter of the individual cell and extending outward farther from the second surface than the first sealing bead; assembling a second separator plate to a second side of the second gasket; and compressing the first and second separator plates toward each other to create a sealing force on the first and second sealing beads.

It should be noted that because any of the above-mentioned sealing beads can have a “height”, or protrude outwardly, a distance that is different from that of any one or more of the other sealing beads, the invention assures that there is sufficient sealing force on each sealing bead, while assuring that none of the sealing beads are over-compressed. This is true even though the different layers of the fuel cell assembly do not all extend the same distance out toward the perimeter of the fuel cell. Moreover, the various sealing forces on the various sealing beads will cause the gaskets and the gas diffusion layers to compress together, eliminating any undesirable gap.

An advantage of the present invention is that gaskets allow for a multi-layer laminate to have non-continuous layers while still providing the appropriate sealing forces around a MEA in a cell. Thus, the single gasket will allow a non-continuous MEA to mate with and seal to a plate without requiring the over-compression one seal section or under-compression on another.

Another advantage of the present invention is that the sealing can be accomplished without requiring the use of an adhesive around the perimeter of the MEA.

### BRIEF DESCRIPTION OF THE DRAWINGS

FIG. 1 is a partially exploded, section cut through a portion of an individual cell of a fuel cell assembly prior to assembling separator plates thereto; and

FIG. 2 is a partially exploded, section cut through a portion of an individual cell according to a second embodiment of the present invention.

### DETAILED DESCRIPTION OF THE PREFERRED EMBODIMENTS

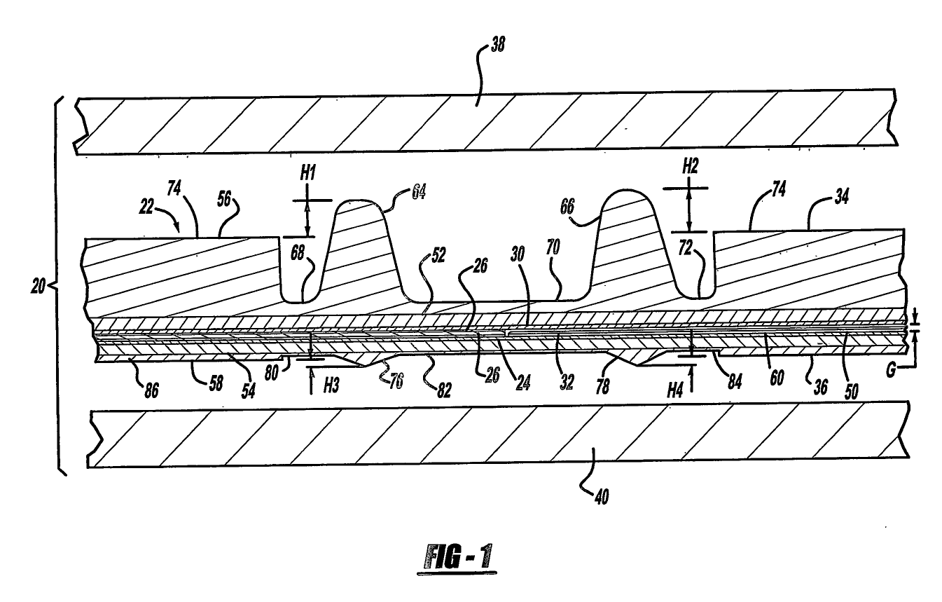

FIG. 1 illustrates a portion of an individual cell 20 for use in a fuel cell assembly. The individual cell 20 preferably includes a gasket unitized membrane electrode assembly (MEA) 22, (although the gasket may be separate rather than unitized, if so desired). The MEA 22 is made up of a membrane 24, with a layer of catalyst material 26 on both sides of the membrane 24. The MEA 22 also includes a first gas diffusion layer (GDL) 30 and second GDL 32 on either side of the layers of catalyst material 26, and a first gasket 34 and a second gasket 36, secured around the perimeters of the first GDL 30 and the second GDL 32, respectively. The gaskets 34, 36 may be secured to the GDLs 30, 32 by adhesive, although other means of securing may be used if so desired, such as molding each gasket to its GDL. The first gasket 34 is shown as much larger and a different shape than the second gasket 36 to illustrate that different shapes and thicknesses may be employed. However, the actual relative thickness of a gasket and shape of its sealing beads depends upon the particulars of the individual cell being sealed. Typically, though, the components of the cell 20 are generally symmetric about the membrane 24.

A first separator plate 38 mounts against the first gasket 34 and the first GDL 30, and a second separator plate 40 mounts against the second gasket 36 and the second GDL 32, in order to form the individual cell 20. Since the relative thicknesses of the various components are very thin, the thicknesses are only depicted schematically in the figures in order to aid in describing the invention. The actual thicknesses of the components may vary according to the particular application of the fuel cell and are known to those skilled in the art.

The membrane 24 is preferably an ion-conducting, polymer, electrolyte membrane, as generally employed in this type of fuel cell application. The catalyst material 26 is preferably platinum or other suitable catalyst material for a typical polymer electrode membrane type of fuel cell application. The first and second GDLs 30, 32 are preferably a carbonized fiber, or may be another suitable gas permeable material for use as an electrode in a fuel cell. The MEA 22 can include a catalyzed membrane with GDLs assembled thereto, or a membrane assembled between two catalyzed GDLs, each of which is known to those skilled in the art.

In this embodiment, the membrane 24 and catalyst layers 26 do not extend outward toward the perimeter as far as the gas diffusion layers 30, 32. This non-continuity of the membrane layer 24 and catalysts 26 creates a gap 50 with a thickness G. A thin electrically insulating filler material 60 fills a portion of the thickness G of the gap 50, and serves to electrically insulate the first gas diffusion layer 30 from the second gas diffusion layer 32.

The gaskets 34, 36, are each preferably a laminated gasket with a thin, flexible carrier 52, 54 upon which an elastomeric seal 56, 58, respectively, is secured. The carriers 52, 54 each mount adjacent its respective gas diffusion layer 30, 32, between which is formed the gap 50. Each carrier 52, 54 preferably has a thickness of less than 1.0 millimeter and is preferably made from a polymer substrate, such as, for example polyimide or polyester. Each elastomeric seal 56, 58 is preferably molded to its carrier 52, 54, although other means of securing the two may also be employed if so desired.

The first gasket 34 includes a first sealing bead 64 and a second sealing bead 66, which each extend around substantially the entire perimeter of the cell 20 in order to accomplish the sealing function when compressed against the first separator plate 38 under a predetermined sealing force. A first set of channels 68, 70,72 are formed adjacent these sealing beads 64, 66. These channels 68, 70, 72 provide space for the sealing beads 64, 66 to expand into when compressed with the sealing force during assembly of the cell 20. The first sealing bead 64, in its uncompressed state, extends beyond the outer surface 74 of the first gasket 34 a distance H1, while the second sealing bead 66, in its uncompressed state, extends beyond the outer surface 74 of the first gasket 34 a distance H2. The distance H2 is greater than distance H1 by about one half of the difference between the thickness of the gap G minus one half the thickness of the filler 60.

The second gasket 36 includes a third sealing bead 76 and a fourth sealing bead 78, which each extend around substantially the entire perimeter of the cell 20 in order to accomplish the sealing function when compressed against the second separator plate 40 under the sealing force. A second set of channels 80, 82, 84 are formed adjacent these sealing beads 76, 78. The channels 80, 82, 84 provide space for the sealing beads 76, 78 to expand into when compressed with the sealing force. The third sealing bead 76, in its uncompressed state, extends beyond the outer surface 86 of the second gasket 36 a distance H3, while the fourth sealing bead 78, in its uncompressed state, extends beyond the outer surface 86 of the second gasket 36 a distance H4. The distance H4 is greater than distance H3 by about one half of the difference between the thickness of the gap G minus one half of the thickness of the filler 60.

Each sealing bead 64, 66, 76, 78 is designed to be compressed against the surface of its corresponding separator plate 38, 40 and held with sufficient sealing force to prevent migration of fluid past the seals 34, 36 along the surface of the separator plates 38, 40. During assembly of a cell 20, as the separator plates 38, 40 are brought toward the gaskets 34, 36, they will first contact the second sealing bead 66 and the fourth sealing bead 78, respectively. As the separator plates 38, 40 continue to be moved toward one another, the sealing beads 66, 78 begin to compress, and the gaskets 34, 36 and GDLs 30, 32 bend toward the filler 60. The plates 38, 40 then contact and begin compressing the first 64 and third 76 sealing beads as well. Since the heights of the second 66 and fourth 78 sealing beads are greater than the first 64 and third 76 sealing beads, when in the fully assembled position, the four sealing beads 64, 66, 76, 78, will be compressed and the GDL's 30, 32 will be compressed against the filler 60. The extra height of the two beads 66, 78 that are nearer to the perimeter of the cell 20 accounts for the open spaces in the gap 50 between the GDLs 30, 32 and the filler 60.

Consequently, by providing for the difference in relative height between the beads on each gasket, this assures that there is sufficient sealing force on each bead 64, 66, 76, 78, while assuring that none of the sealing beads are over-compressed. This is true even though the different layers do not all extend the same distance out toward the perimeter of the cell 20. Moreover, the sealing force on sealing beads 66, 78 will cause the gaskets 34, 36 and gas diffusion layers 30, 23 to compress together, eliminating the gap 50.

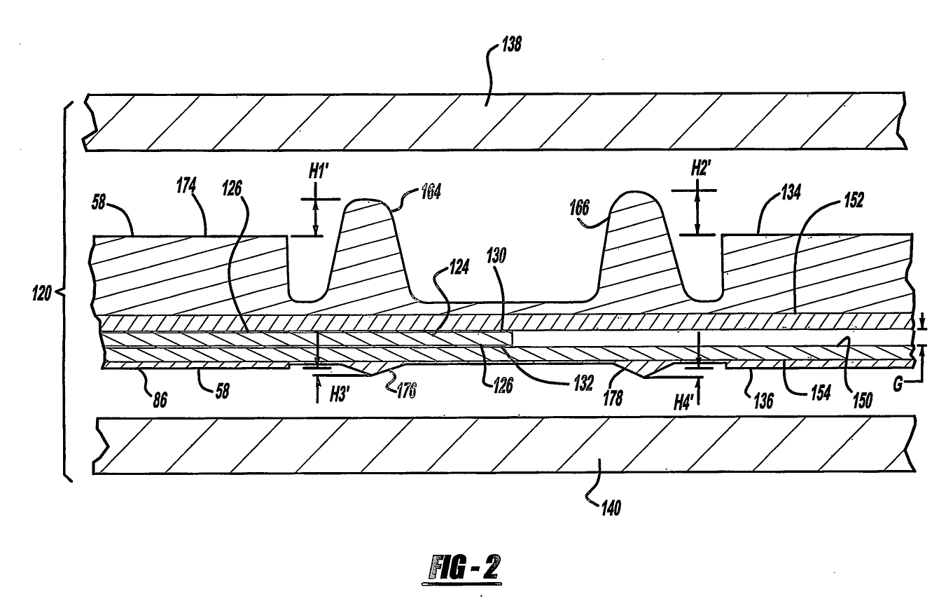

FIG. 2 illustrates another embodiment of the present invention. In this embodiment, similar elements to the first embodiment will be similarly designated, but with a 100 series number. The first gas diffusion layer 130 and the second gas diffusion layer 132 now only extend toward the perimeter about as far as the membrane 124 and catalyst layers 126, while the first and second carriers 152, 154 and the first and second elastomeric seals 156, 158 extend closer to the perimeter of the individual cell 120. This creates a gap 150 with a thickness of G′. With this embodiment, since the first GDL 130 cannot come into contact with the second GDL 132, no filler material is needed to electrically insulate them from each other. Consequently, the thickness G′ of the gap 150 is about equal to the combined thicknesses of the membrane 124, catalyst layers 126, and the GDLs 130, 132. The differences in heights of the four sealing beads 164, 166, 176, 178 above their respective surfaces 174, 186 will be represented by the following equation: (H2′-H1+)+(H4′-H3′)=G′. Similar to the first embodiment, as the separator plates 138, 140 are compressed to the gaskets 134, 136, the gap 150 will be closed and sealed, and the sealing beads 164, 166, 176, 178 will be compressed with the appropriate amount of sealing force against the plates 138, 140.

As mentioned above, in any of the embodiments of the invention, any of the above-mentioned sealing beads can have a “height”, or protrude outwardly away, a distance that is different from that of any one or more of the other sealing beads. Thus, the invention assures that there is sufficient sealing force on each sealing bead, while assuring that none of the sealing beads are over-compressed. This is true even though the different layers of the fuel cell assembly do not all extend the same distance out toward the perimeter of the fuel cell. Moreover, the various sealing forces on the various sealing beads will cause the gaskets and the gas diffusion layers to compress together, eliminating any undesirable gap.

While certain embodiments of the present invention have been described in detail, those familiar with the art to which this invention relates will recognize various alternative designs and embodiments for practicing the invention as defined by the following claims.

What is claimed is:

1. An apparatus for use in an individual cell of a fuel cell assembly comprising:
a membrane electrode assembly having a plurality of-layers, with a portion of the plurality of layers being discontinuous relative to the other layers;
a first gasket mounted to a first side of the membrane electrode assembly and including a first surface adapted to be adjacent to a first separator plate, a first sealing bead extending beyond the first surface a first distance, and a second sealing bead extending beyond the first surface a second distance, with the second distance being greater than the first distance; and
a second gasket mounted to a second side of the membrane electrode assembly and including a second surface adapted to be adjacent to a second separator plate, a third sealing bead extending beyond the second surface a third distance, and a fourth sealing bead extending beyond the second surface a fourth distance, with the fourth distance being greater than the third distance,
at least one of said third and fourth distances being different from either of said first and second distances.

2. The apparatus of claim 1, wherein each sealing bead includes at least one channel adjacent thereto.

3. The apparatus of claim 1, wherein the plurality of layers includes a membrane, a first catalyst layer located adjacent to a first side of the membrane, a second catalyst layer located adjacent to a second side of the membrane, a first gas diffusion layer located adjacent to the first catalyst layer, and a second gas diffusion layer located adjacent to the second catalyst layer.

4. The apparatus of claim 3, wherein the membrane, the first catalyst layer and the second catalyst layer each include a perimeter located adjacent one another, and the first gas diffusion layer, the second gas diffusion layer and the first gasket each have a perimeter that extends beyond the perimeters of the membrane, the first catalyst layer and the second catalyst layer.

5. The apparatus of claim 3, wherein the membrane, the first catalyst layer, the second catalyst layer, the first gas diffusion layer and the second gas diffusion layer each include a perimeter located adjacent one another, and the first gasket has a perimeter that extends beyond the other perimeters.

6. The apparatus of claim 1, wherein the first gasket includes a carrier layer that is adjacent to the membrane electrode assembly and an elastomeric seal layer secured to the carrier layer that is adapted to be adjacent to the first separator plate.
